(19) United States
(12) Patent Application Publication
(10) Pub. No.: US 2014/0245154 A1
(43) Pub. Date: Aug. 28, 2014

(54) Zolog Intelligent Human Language Interface For Business Software Applications

(71) Applicant: Arun Jain, Iselin, NJ (US)

(72) Inventor: Arun Jain, Iselin, NJ (US)

(21) Appl. No.: 13/500,071

(22) Filed: Apr. 4, 2012

(30) Foreign Application Priority Data
Sep. 14, 2009 (IN) 2214/CHE/2009
Sep. 9, 2010 (IN) PCT/IN2010/000603

(51) Int. Cl. G06F 3/16; G06F 3/048

(52) U.S. Cl. CPC G06F 3/167; G06F 3/048
USPC 715/728

(57) ABSTRACT

A method of creating ZOLOG BAR software, laid above a business software application, which is used to provide instructions to business software application is disclosed. The method comprises programming a signal processor hardware to host the ZOLOG Technology Software; enabling users to provide inputs through the ZOLOG BAR in one or more of a most intuitive verbal and written human way for carrying out a particular task by which instructions are sent to business software applications, processing the instructions and present the summary for review to the user.

### CROSS REFERENCE TO RELATED APPLICATIONS

This application is the complete specification of the invention originally disclosed in the Indian provisional patent application 2214/CHE/2009 filed on 14.09.2009, and PCT/IN2010/000603 filed on 09.09.2010 from which it claims the priority date, both incorporated by reference herein.

### BACKGROUND OF THE INVENTION

1. Field of the Invention

The invention under consideration is in the field of Business Software Application and design of the application layer through which humans interact with software applications for giving instructions.

2. Description of the Related Art

World over, Computer Application Interfaces are designed to use a navigation tool bar with menu options. Typically, the menu bar, in various forms and shapes is designed to provide the first set of blocks for various possible tasks that can be performed by the application. With further clicks on any specific block, the User Interface (UI) leads the user to the next screen or drop-down options and so on. This is how traditionally UIs are designed & implemented.

Shortcomings of current approaches to traditional application user interface design causes a long time-to-complete an activity and long learning curve for new users.

In most cases, it takes several clicks for end-users to reach the desired level at which the activity can be completed. Also, the learning curve for a new user when faced with a new application is long and tends to be similar across applications.

High Investment in User Training.

It also takes significant amount of user training on various modules of the application before the user can start using the system effectively. This approach becomes very time consuming especially in cases where a large number of users need to be trained on a particular application, when the effort can require several hours/man-months of training.

Higher Design Effort Required to Create a ‘Minimum-Click’ UI Today.

At the design level, significant amount of research has been performed by experts in the GUI field to ensure that the user uses minimum clicks to complete a particular task. Despite this, it takes long time for GUI interface designers to build application pages with current UI approaches even after best possible grouping of various features. The outcome also continues to remain very subjective and person dependant. Furthermore, any new modules added to the application also necessitate a redesign of the application menu and drop-downs.

### SUMMARY OF THE INVENTION

A zolog intelligent human language interface for business software applications is described.

In some embodiments, ZOLOG is a new-age application user interface (UI) design methodology which makes the whole experience of using a software application much more easier based on the most logical and natural human instructions for initiating a particular activity or task. The ZOLOG Framework comprises of powerful features that makes it a unique and revolutionary approach in the software applications world.

### BRIEF DESCRIPTION OF THE DRAWINGS

FIG. 1 is a block diagram depicting a high level Zolog architecture, according to one or more embodiments; and

FIG. 2A and FIG. 2B depict a data flow diagram of zolog, according to one or more embodiments;

While the method and apparatus is described herein by way of example for several embodiments and illustrative drawings, those skilled in the art will recognize that a zolog intelligent human language interface for business software applications is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of a ZOLOG intelligent human language interface for business software applications defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

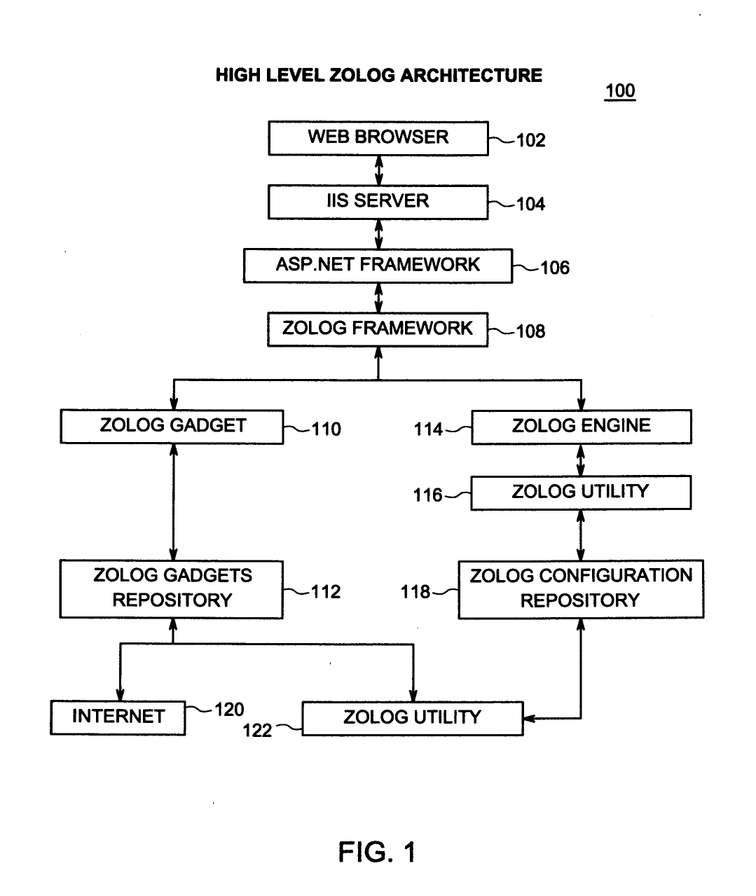

FIG. 1 is a block diagram depicting a high level Zolog architecture 100, according to one or more embodiments. Various embodiments enable interacting with a software intuitive for most users, and increases efficiency of the interaction, for example, by reducing the number of operations, such as “clicks” required, and form the foundation for an easy to use user interface usable in several operating environments.

The ZOLOG framework 108, which consists of ZOLOG Engine 114 and ZOLOG gadget 110, built on the ASP. NET framework 108 and IIS server 104.

Web application accesses the ZOLOG framework 108 to complete any form transactions and for pulling the forms through form aliases and also to view the data in the form of the ZOLOG gadgets 110.

In some embodiments, a ZOLOG engine 114 searches and executes user queries on the ZOLOG configuration Repository 118 through the ZOLOG utility 122.

In some embodiments, a ZOLOG engine 114 works through the ZOLOG Utility 122 to do configurations such as add/remove search words, form aliases and ZOLOG functions using which any form transaction can be completed at one click.

These configurations are stored in the ZOLOG configuration Repository 118.

The ZOLOG framework 108, Zolog gadget 110, ZOLOG Functions, forms or aliases can be accessed through the Web application, either from Internet or Intranet.

In some embodiments, the ZOLOG gadget 110 is miniature of information from various sources. The ZOLOG gadget 110 are created through gadget master, and stored in the ZOLOG gadgets repository 112. Whenever a user adds a new gadget, it is reflected in the Repository.

In some embodiments, the ZOLOG configuration repository 118 consists of search words and also the functions to either open the respective form or do in-line transactions in the ZOLOG bar.

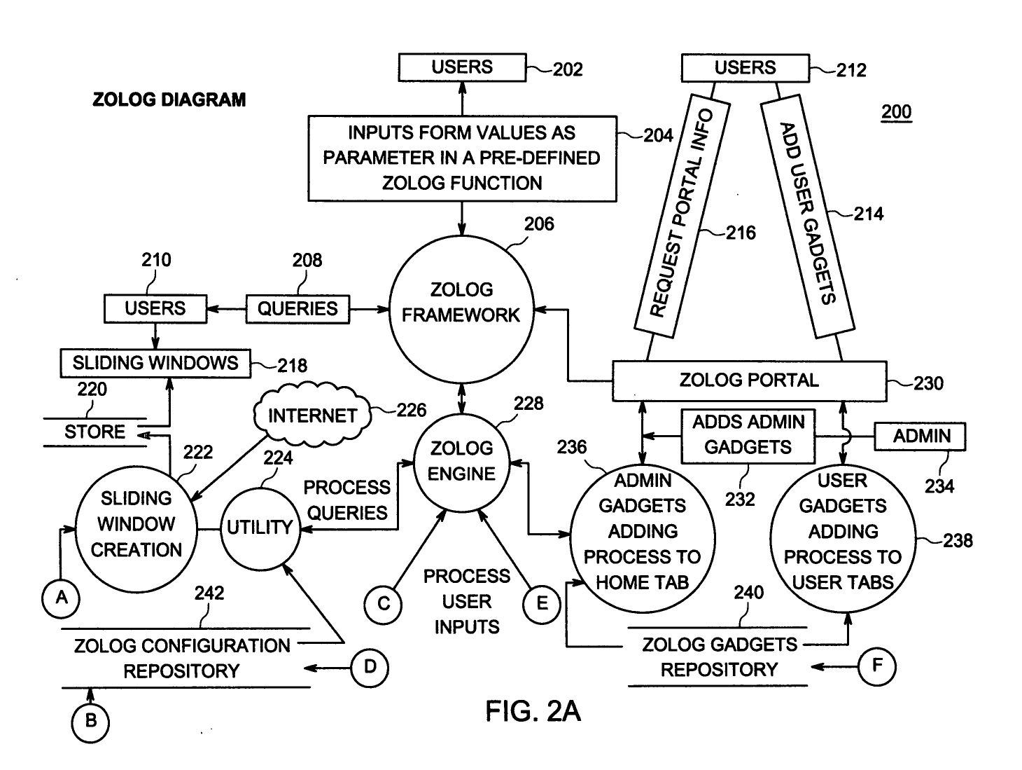

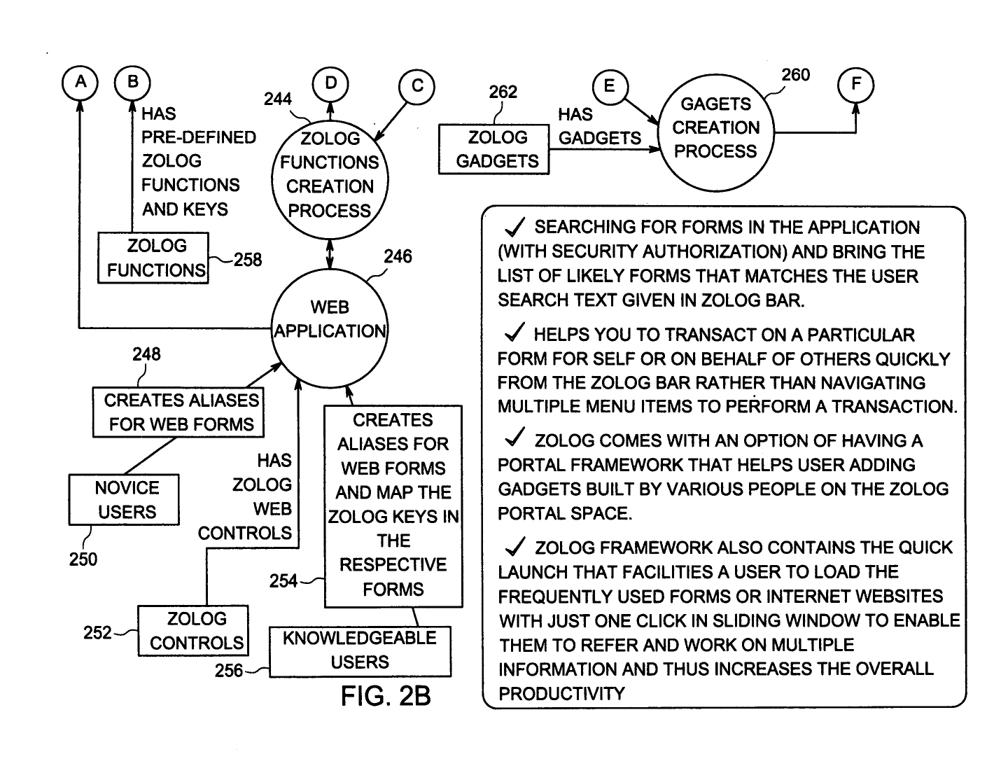

FIG. 2A and FIG. 2B depict a data flow diagram of zolog, according to one or more embodiments

In some embodiments, the zolog framework 206 consists of an efficient and intelligent ‘search engine’, such as zolog engine 228 and an innovative ‘Gadget based portal, such as zolog portal 230’. The zolog engine 228 helps the user by triggering his/her thoughts, prompting the possible available options as he/she keeps typing the words or text to initiate a particular task. Publicly known “Type forwarding” feature is being used to enable this.

In some embodiments, the ZOLOG can be accessed by both admin 234 and normal users, such as users 210.

The form aliases, ZOLOG functions 258 and the gadget masters are created and managed by the admin 234. The gadgets added by the admin 234 are available in the home tab of the ZOLOG portal 230 page.

In some embodiments, the normal user 210 can also personalize these settings that would be applicable only for that user.

These configurations are stored in the ZOLOG configuration Repository 242 for faster accessing.

The ZOLOG Framework 206 also contains ‘Quick Launch’, a feature that facilitates the user in maintaining and accessing frequently used forms or Internet websites with just one click, which shows the selected URL in a sliding window 218.

This sliding window 218 feature helps to refer and work on multiple information areas within a single window and thus increases the overall productivity.

All users can create and manage the sliding windows 218.

User can stack up to a maximum of 10 quick launch items of 5 each on both left and right pane.

The concepthuman Intuitive User Interface for Business Software Applications The ZOLOG improves GUI design through menu-optimization, creation of drop downs and tabs etc could provide only incremental and limited enhancements to productivity.

In contrast, a menu-free approach to design of software application UI would be able to deliver an exponentially high user experience for applications. This would necessitate a revolutionary concept in UI design based on natural human tendencies and approaches to performing a particular task or activity.

In response to this need, a menu-free, simple ZOLOG bar based graphical user interface (GUI) has been designed.

This is an innovative concept of interacting with business software applications, which relies on most common human approaches and tendencies for performing a particular task.

Various embodiments of the invention as further defined by the claims relate to innovative design on all software applications, on all software platforms.

The multifold benefits of this alternative approach to UI Design are:

Intuitive Transaction Execution

Zero Leveraging Time

faster execution of transactions

### APPENDIX A

Sample set of Instructions that would be given by application user

Given below is sample instruction set, which will be detailed out in below specification further.

In one preferred embodiment of the application, wherein the application is directed towards Human Resources Management, the following may be the requests that may be included in the type forwarding scheme among others.

Leave Request

I want to apply leave on [Date]/[Day]

I want leave on [Date]/[Day]

I want permission to be away from office on [Date]/[Day] (Mease cancel my leave on [DaleJ/[Day]

Cancel my travel on [Date]/[Day]

I want to regularize attendance on

I wish to resign effective from

I wish to encash my leave for xxx days

Reimbursement Requests

I want reimbursement for [purpose]

Help Requests

I need help on [ ]

Travel Requests

I wish to travel to on [Date]/[Day]

I want to travel from [City Name] to [City Name]

I want to travel from [City Name] to [City Name] on [Date]/[Day] 1 need pick up on [Date]/[Day]

I need pick up at [City Name]

Service Requests

I acquire a laptop

I wish to officiate

I need visa for [Country]

I need salary advance of [Amount]

I need a salary certificate

I require business cards

Training Requests

I wish to attend training on

What are the holidays next month?

It will be appreciated by those skilled in the art that the above embodiment is only a modification of the invention for the above embodiment, and the invention can be extended to many different fields where a search engine interface can be used to pre-fill full a form and such modifications and applications will also fall within the scope of the present invention. The invention as described herein is only limited by the specific limitations that are acknowledged in the claims to the invention made herein.

Key features of the invention are as follows:

The invention comprises a method of creating ZOLOG BAR software, operably interacting with a business software application, where the ZOLOG BAR assists in providing instructions to business software applications. The method comprising the steps of programming a signal or multi-processor hardware to host the ZOLOG software, enabling users to type in a ZOLOG interface bar for carrying out a particular task by which instructions are sent to business software applications which then process the instructions and present the summary for review to the user, and executing the task upon approval by the user.

The user can give instructions in intuitive human language both using spoken and written form of expression. The instruction can be given by typing on a ZOLOG interlace bar. The instruction given by typing, inventors are patenting certain statements for giving instructions, a sample set for the same is described further below with an example, and detailed instructions set will be mentioned in the following description. The instruction can be given through voice recognition software or any third party interface software.

Zolog interacts with the business application to locate relevant form or equivalent object for processing user instructions. The form or equivalent object in the business application get auto filled based on instruction given by the user. The filled form or equivalent object is presented to the user for verification and submission for processing upon user verification to the zolog software enabled hardware.

The instructions can be provided in all known human languages using the zolog interface, such as English, Spanish, French, German, Portuguese, Arabic, Urdu, Persian, Hindi, Tamil, Telugu, Kannada, Chinese, Japanese, Korean, Thai, Malayalam, Bengali, Russian, among others.

The instructions can be applied to various business applications including and not limited to Human Resource Management Software Business Applications, Banking & Financial Software Business Applications, Insurance Software Business Applications, Retail software business applications, Health care Software Business Applications, and so on.

The method can be delivered around various devices like Web Browsers (Internet explorer. Netscape. Google Chrome. Mozilla Firefox, etc), Mobile Devices, PDAs & Mini Computers. ATMs, Kiosks, among others.

The method can be applied through any combination of Software & Hardware Net Framework on Windows Platform/Linux/Macintosh Operating Systems, Java Framework on Windows Platform/Linux/Macintosh Operating Systems, Open Systems Software on Windows Platform/Linux/Macintosh Operating Systems.

The invention comprises a method of creating ZOLOG BAR software operably coupled to a business software application, in order to provide instructions to the business software application. According to one embodiment, a computer implemented method comprises the steps of programming a signal processor hardware to host the ZOLOG Technology Software, enabling users to provide inputs through the ZOLOG Bar in intuitive verbal or written human way for carrying out a particular task by which instructions are sent to business software applications, which then process the instructions and present the summary to the user for review, and executing the task upon approval by the user.

In some embodiments, the user provides instructions by speaking, that is, by using a voice recognition software as known in the art, for receiving spoken form of expression. In several embodiments, the user provides instructions using a keyboard or other text based form of providing input, such as keyboards, touch screen or gesture input, enabled or coupled with optical character recognition, as known in the art.

According to several embodiments, input provided by a user include Leave Requests, such as “I want to apply leave on [Date]/[Day],” “I want leave on [Date]/[Day],” “I want permission to be away from office on [Date]/[Day],” “Please cancel my leave on [Date]/[Day],” “Cancel my travel on [Date]/[Day],” and several other such instructions in an everyday use intuitive language, as discussed above.

According to several embodiments, the zolog bar or software identifies different elements of the user inputs provided to interact with the business application to locate relevant form or equivalent object, that is, operational parameters, for example words such as nouns, functional parameters, for example, words such as verbs, for processing user instructions. In the example where a user inputs “I want to apply for a leave on [Date]/[Day],” Zolog identifies words such as “apply,” “leave,” “[Date]/[Day]” and the like. Zolog uses parts of speech tagging and other known techniques to identify such operational, functional, and quantifiable parameters matching such user input. For example, in the context of “leave” and “apply” sent by a particular person identifiable by an employee ID, or an email ID and the like, the Zolog application looks for date input, and attempts to identify a day, date, month, year or a combination thereof. Further, Zolog auto fills or maps the operational words, requester information, quantifiable parameters identified from the user input, to the relevant places of an application software. According to some embodiments, the relevant places of an application software include a form as generally known for receiving user inputs, or an equivalent object. Once a user input is populated or mapped to form, the populated or partially populated form is presented to the user for verification by the user, and submission for processing upon user verification to the application software enabled with Zolog, for further processing.

According to several embodiments, Zolog is applied to the application software of Mobile Devices, PDAs, Mini Computers, ATMs, Kiosks. According to several embodiments, instructions can be provided in different languages, including but not limited to, English, Spanish, French, German, Portuguese, Arabic, Urdu, Persian, Hindi, Tamil, Telugu, Kannada, Chinese, Japanese, Korean, Thai, Malayalam, Bengali, Russian using the Zolog interface.

According to several embodiments, application software include software for Human Resource Management, Software Business Applications, Banking & Financial Software Business Applications, Insurance Software Business Applications, Retail Software Business Applications, Healthcare Software Business Applications.

According to several embodiments, application software include user applications including Web Browsers such as Internet Explorer; Netscape Navigator, Google Chrome, Mozilla Firefox, or other web based interaction software clients.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The embodiments of the present invention may be embodied as methods, system, and/or electronic devices. Accordingly, the embodiments of the present invention may be embodied in hardware and/or in software (including firmware, resident software, micro-code, etc.), which may be generally referred to herein as a “circuit” or “module”. The methods described herein may be implemented in hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of the invention. Finally, structures and functionality presented as discrete components in the example configurations may be implemented as a combined structure or component. These and other variations, modifications, additions, and improvements may fall within the scope of embodiments as defined. It will be further appreciated that the functionality of any or all of the modules may also be implemented using discrete hardware components, one or more Application Specific Integrated Circuits (ASICs), or programmed Digital Signal Processors or microcontrollers.

The foregoing is directed to embodiments of the present invention, other and further embodiments of the invention may be devised without departing from the basic scope thereof.

1. A computer implemented method comprising:
receiving a user input in natural language;
analyzing the user input to identify components including operational parameters, functional parameters, and quantifiable parameters; and
mapping at least one component from the component to at least one form field for input to a software application.

2. The method of claim 1 further comprising communicating the at least one component to the software application.

3. An apparatus comprising:
one or more processors and further comprising:
a software application; and
a user interface layer operably coupled to the software application, the user interface layer for receiving user input in natural language, analyzing the user input to identify components including operational parameters, functional parameters, and quantifiable parameters, and mapping at least one component from the component to at least one form field for input to the software application.
